(19) United States
(12) Patent Application Publication
(10) Pub. No.: US 2005/0235802 A1
(43) Pub. Date: Oct. 27, 2005

(54) Victor Grand Piano Pinblock Extractor

(75) Inventor: Harry Malon Victorine, Roanoke, VA (US)

Correspondence Address: HARRY M. VICTORINE, 2322 AVENHAM AVENUE, ROANOKE, VA, 24014, US

(73) Assignee: Harry Victorine, Roanoke, VA (US)

(21) Appl. No.: 10/709,207

(22) Filed: Apr. 21, 2004

(51) Int. Cl. G10C 3/10

(52) U.S. Cl. 84/200

(57) ABSTRACT

The inventions are a device and method specifically designed to separate the pinblock (or wrestplank) from the piano case in certain grand pianos wherein the pinblock is installed with shims, wood dowels and glue along three edges so as to make the pinblock an integral part of the case. With the device and method this as accomplished quickly, easily and cleanly along the glue line by applying a controlled force between the two parts and without risk of damage to the finished parts of the piano case.

### BACKGROUND OF INVENTION

The tuning pins in a grand piano are installed in a laminated plank called a pinblock or wrestplank which is located beneath the large cast iron harp. Herein, it will be called a pinblock.

For more than a hundred years, some manufacturers of grand pianos have installed the pinblocks in the piano cases with wooden dowels, shims and glue along three sides and bottom of the pinblock, making it an integral part of the case.

Over a period of time the pinblocks will wear and otherwise deteriorate to a point where they will no longer securely hold the tuning pins and the pinblocks will have to be replaced.

The known methods of removing the old blocks involve the use of hammers, chisels, saws of various sorts and electric routers. All of these methods are time consuming, uncontrollable and often result in residual damage to the finished parts of the cases.

### SUMMARY OF INVENTION

The inventions are a device and a method specifically designed for the sole purpose of quickly, easily and cleanly separating the pinblock from the piano case along the glue line between the two parts. The result is predictable and is accomplished without any residual damage to the finished parts of the case.

### BRIEF DESCRIPTION OF DRAWINGS

FIG. 1 Top view showing offset bolt head

FIG. 2 Side view showing bolt head and shaft and bottom recess

FIG. 3 Bottom view

FIG. 4 Graphic three dimension view

FIG. 5 Showing saw cut and holes for device shaft

FIG. 6 Showing device inserted in pinblock

FIG. 7 Showing wrench on bolt head ready for rotation

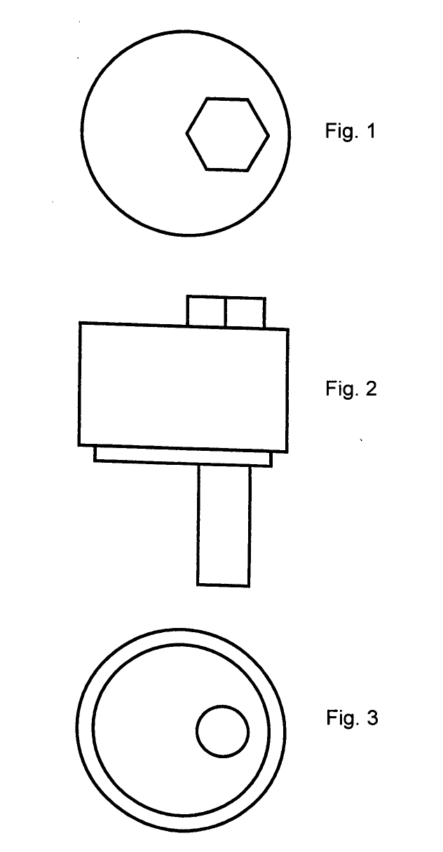

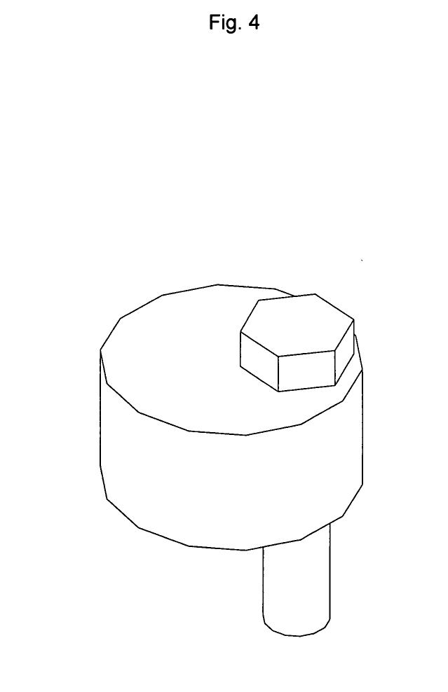

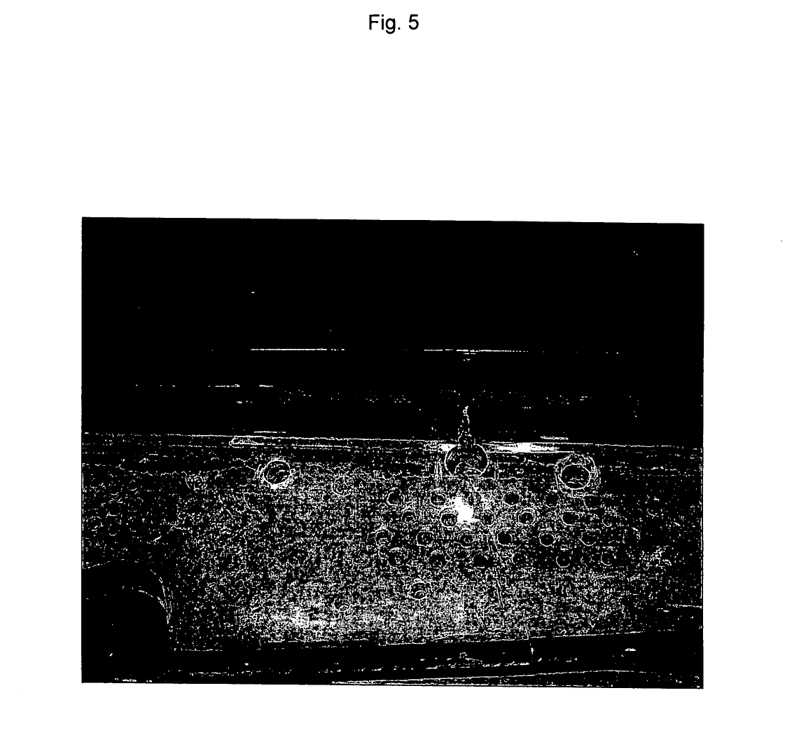

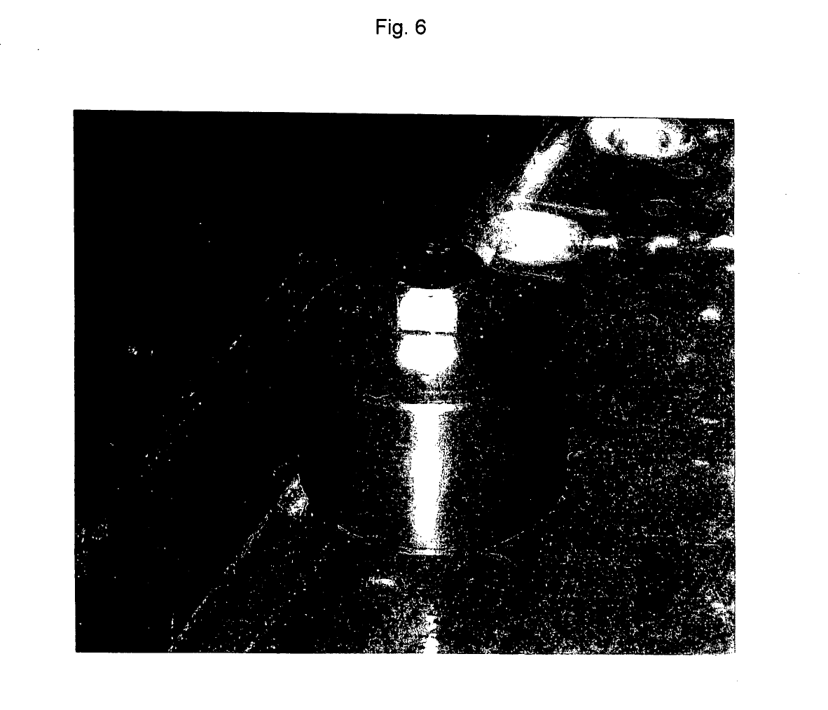

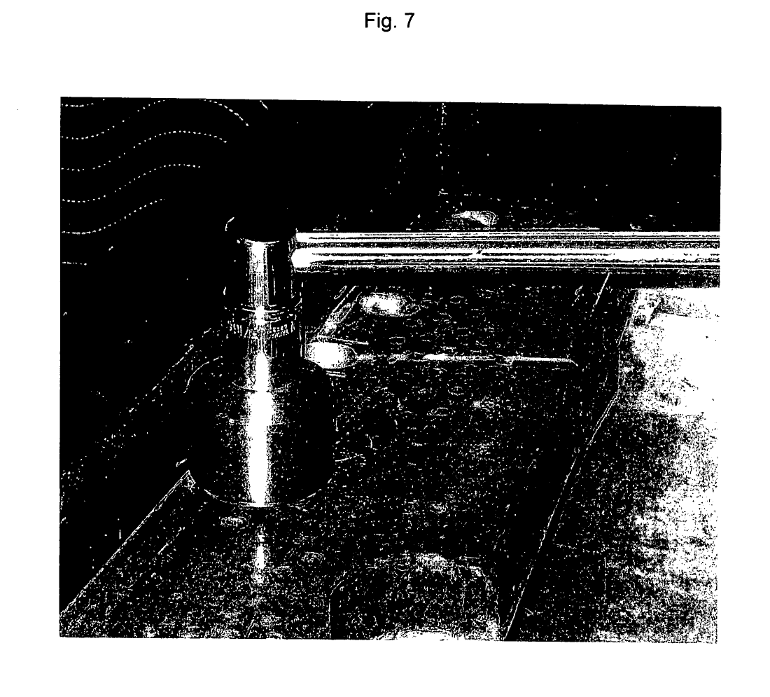

### DETAILED DESCRIPTION

The Device

Material: Steel or Aluminum
Cylinder
Diameter: 2½″
Length: 1 11/16″
Bottom 3/16″× 3/16
Shaft
Length: 2¼″
Diameter: ⅝″

Fabrication

1. The cylinder is cut to the specified length from a stock mild steel or aluminum round bar.

2. The cylinder is placed in a four jaw chuck in a lathe and centered for a recess cut in the bottom measuring 3/16″× 3/16″ and finish cuts top and bottom.

3. The cylinder is moved ½″ off center in the chuck then drilled through its length for a ⅝″-11 threal.

4. The cylinder is tapped top and bottom for a ⅝″-11 threal to a depth of ¾″.

5. The shaft is made from a Grade 5 hex head ⅝″-11 machi1e screw 3″ long.

6. The head of the machine screw is cut off 1½″ from the thread and the cut is finished on the threaded part. The head part is discarded.

7. The thread of the shaft is cut to a length of ¾″ remaining, is screwed in to the bottom of the cylinder and tightened.

8. A Grade 5 hex head ⅝″-11 machi1e screw ¾″ long is screwed into the top of the cylinder and tightened.

9. The operating lever for the device is a 15/16″ wrench applied to the bolt head on the top of the device.

The Method

1. The pinblock spans the full width of the inside of the piano case.

2. There are usually three dowels in the treble end and two in the bass end. For reference, facing the piano from the keyboard, the treble end is on the right and the bass on the left. With a half-inch bit, drill out the dowels to the depth of the pinblock.

3. Place the blade of the saw in the hole and make a cut, at a slight angle toward the bass end, to the free edge.

4. With a ⅝″ bit drill a hole about eight inches from each side of the saw cut and on a center ⅞″ from the front edge. You might also make a third similar hole a foot or so from the treble end. These holes should be as nearly perpendicular as possible.

5. Place the shaft of the tool in the hole on the treble side of the saw cut. It will go in only gooway.

6. Place a socket wrench on the bolt head and with a steady and increasing force rotate the device clockwise through one-half turn. The pinblock will release quite suddenly, bringing with it the horizontal blind dowels in the front of the case.

7. Repeat from step five for the hole on the bass side to free the small piece remaining at the bass end.

1. Here is what is claimed as my inventions.

2. A device according to claim one wherein a steel or aluminum cylinder is 2½″ in diameter and 1½″ in length

3. A device according to claim 1 wherein the said cylinder has a recess at the bottom 3/16″ deep and 3/16″ high.

4. A device according to claim 1 wherein the said cylinder has a hole drilled through its length and is offset from the center of the cylinder by ½″, the hole being drilled and tapped top and bottom for a ⅝-11 thread for 1 depth of ¾″.

5. A device according to claim 1 wherein a steel shaft is 2¼″ long and ⅝″ in diameter.

6. A device in claim 1 wherein the steel shaft is threaded on one end with a ⅝-11 thread with1a length of ¾″.

7. A device in claim 1 wherein the steel shaft is threaded fully into the hole in the bottom of said cylinder and tightened.

8. A device according to claim 1 wherein a ⅝-11 machine screw ¾″ in length is threaded into the top of said cylinder and tightened.

9. A method according to claim 2 wherein using the device in claim 1 will quickly and easily effect the removal of a grand piano pinblock (or wrestplank) when the pinblock has been incorporated in the piano case by means of shims, glue and dowels on three sides and the bottom of the of the pinblock.

10. A method in claim 2 wherein the dowels in the ends of the pinblock are drilled out
A method according to claim 2 wherein a hole of sufficient size to accommodate the blade of a saw is drilled in the pinblock near its end and flush with front of the piano case.
A method according to claim 2 wherein a saw cut is made from the hole as above to the free edge of the pinblock, the cut being made at a slight angle toward the near end.
A method according to claim 2 wherein a hole ⅝″ in diameter is drilled 2″ from each side of the saw cut and on a center ⅞″ from the front of the case.
A method according to claim 2 wherein the device in claim 1 is rotated with a wrench through one-half turn to accomplish the separation between the pinblock and the piano case.
A method according to claim 2 wherein the device in claim 1 is rotated with a wrench one-half turn to accomplish the separation between the pinblock and the piano case.
A method according to claim 2 wherein the remaining part of the pinblock is removed in the same manner as above.
